(19) United States
(12) Patent Application Publication
(10) Pub. No.: US 2025/0087723 A1
(43) Pub. Date: Mar. 13, 2025

(54) FUEL CELL SYSTEM COMPRISING A HEAT PIPE

(71) Applicant: Aerostack GmbH, Dettingen an der Erms (DE)

(72) Inventors: Markus SCHUDY, Dettingen an der Erms (DE); Marcus-Benedict BUNTZ, Dettingen an der Erms (DE); Christoph ZIEGLER, Dettingen an der Erms (DE)

(21) Appl. No.: 18/883,139

(22) Filed: Sep. 12, 2024

(30) Foreign Application Priority Data
Sep. 13, 2023 (DE) 102023124704.2

(51) Int. Cl. H01M 8/04007; B64D 27/355; B64D 33/08; H01M 8/04029

(52) U.S. Cl. CPC H01M 8/04074; B64D 27/355; B64D 33/08; H01M 8/04029; H01M 2250/20

(57) ABSTRACT

A fuel cell system having a two-phase cooling system includes at least one fuel cell having a coolant inlet and a coolant outlet, an accumulator in fluid connection with the fuel cell to contain coolant which flows out of the fuel cell in a liquid phase in a first portion and in a gas phase in a second portion, a condenser in fluid connection with the accumulator to condense and supercool the coolant, a thermally conductive element between the coolant inlet and the coolant outlet to transfer heat from the coolant outlet to the coolant inlet.

### TECHNICAL FIELD

The disclosure herein in general to the technical field of aviation. In particular, the description relates to a fuel cell system having two-phase cooling comprising a thermal element and to an aircraft comprising such a fuel cell system.

### BACKGROUND

Fuel cells are a possible solution for generating power in aircraft propulsion systems or emission-free auxiliary power units (APU) without unwanted emissions. Polymer electrolyte membrane fuel cells (PEMFC) generate energy and power through the electrochemical reaction of hydrogen and oxygen to form water. This reaction involves the unavoidable generation of heat, which must be dissipated. This is realized by liquid cooling in commercial fuel cell stacks.

A potential alternative with a potential for considerable weight reduction at the system level is to replace liquid cooling with two-phase cooling. Use is made here of the latent heat of evaporation to dissipate large amounts of heat from the fuel cells. In addition, the high heat transfer coefficient improves the performance of the thermal management system compared to single-phase cooling. Two-phase cooling is based on the phase transitions in the evaporator (fuel cells) and in the heat exchanger in relation to the environment (condenser). In order to be able to pump the coolant to the fuel cell, the coolant must be supercooled, i.e., it must be in the liquid state (avoiding pump cavitation). Supercooling refers to the temperature range below the boiling point of the coolant. The supercooled coolant then reaches the fuel cell, where its temperature is increased, and the coolant begins to boil. The presence of this steep temperature gradient in the inlet zone can cause damage to the fuel cell. Excessively low temperatures in this region can lead to condensation of water in the gas ducts (flooding). In order to overcome this risk and other risks, a preheater or recuperator is generally used upstream of the evaporator (fuel cell). However, the preheater/recuperator can be prohibitively large and reduce the weight benefits of two-phase cooling.

### SUMMARY

It can be considered to be an object of the disclosure herein to provide a fuel cell system having reduced weight.

This object is achieved by the subject matter and embodiments disclosed herein.

According to one aspect, a fuel cell system having a two-phase cooling system is specified. The fuel cell system comprises at least one fuel cell having a coolant inlet and a coolant outlet. Furthermore, a thermally conductive element is provided between the coolant inlet and the coolant outlet, the thermally conductive element being adapted to transfer heat from the coolant outlet to the coolant inlet.

A fuel cell system is a technological unit which consists of multiple components and is used to convert chemical energy into electrical energy by electrochemical reactions. It generally comprises one or more fuel cells which act as electrochemical cells and are the main component of the system. In addition, the system contains further components such as a fuel supply mechanism, an oxidizer supply mechanism, an electrolyte solution, electrodes, a catalyst and an electrical connection.

The fuel cell system uses a chemical reaction between a fuel and an oxidizer, typically hydrogen and oxygen, in order to generate power electrochemically. This produces water as the only product, which makes the fuel cell system an environmentally friendly source of energy. The electrical energy generated can then be used to supply electrical devices, to supply vehicles or to generate power in various applications.

A two-phase cooling system is a cooling solution intended for efficient dissipation of large amounts of heat by use of the phase transition from liquid to vapor. It is frequently used in situations where conventional single-phase cooling systems reach their limits and cannot provide sufficient heat dissipation.

A two-phase cooling system uses a coolant which can exist in both liquid and gaseous form at appropriate temperatures and pressures. The coolant absorbs heat from the source to be cooled and evaporates, thereby transitioning from a liquid state to a gaseous state. The resultant vapor absorbs large amounts of heat.

The phase change from liquid to vapor allows effective heat transfer. This leads to improved cooling performance and to more efficient heat dissipation.

A two-phase cooling system generally consists of an evaporator, in which the coolant absorbs heat and evaporates, and a condenser, in which the vapor recondenses and releases the heat. The condensate is then returned to the evaporator to continue the cooling circuit.

This type of cooling system is used in various applications, including the cooling of high-performance electronics, processors, fuel cells, engines and other thermally demanding systems where efficient heat dissipation is of great importance.

A condenser in the context of the disclosure herein is a component or device used to condense vapor or gas into a liquid phase. The condenser is in fluid connection with the accumulator, which means that the coolant can circulate between the two components.

The main function of the condenser is to condense the coolant by release of heat and thus transition from a gaseous state to a liquid state. This process is generally done by cooling of the vapor or gas by contacting thereof with a medium of lower temperature via the condenser. This cooling causes the molecules of the vapor or gas to come together and condense, as a result of which they are collected in liquid form.

Furthermore, the condenser is adapted such that it can supercool the coolant. Supercooling means that the temperature of the condensed coolant is below its saturation point, i.e., below the temperature at which it would normally condense. This allows more heat to be absorbed by the coolant before it evaporates once again or is passed on. Supercooling is important for avoiding cavitation and for ensuring that the coolant maintains its condensation form.

A thermally conductive element between the coolant inlet and the coolant outlet is a component used to transfer heat from a hotter point in the cooling circuit to a colder point. In the following, this configuration is defined and the advantages thereof are indicated.

The thermally conductive element is a connection or structure which has good thermal conductivity and which is installed between the coolant inlet and the coolant outlet. It may, for example, consist of a material such as metal or a thermally conductive plastic.

The main advantage of a thermally conductive element between the coolant inlet and the coolant outlet is efficient heat transfer. The use of a thermally conductive element allows effective transfer of the heat present in the coolant outlet to the coolant inlet. This improves heat dissipation and stabilizes the temperature in the cooling circuit by preheating of the cooling fluid.

Another advantage is the reduction of heat losses. The use of a thermally conductive element means that heat is transferred directly from one point to another without being lost unnecessarily. This increases the efficiency of the cooling circuit and reduces energy consumption.

Another positive effect of this configuration is that the temperature distribution in the system is improved. The efficient heat transfer between the coolant inlet and the coolant outlet achieves a more uniform distribution of temperatures in the cooling circuit. This avoids hotspots and ensures better cooling of the relevant components.

Furthermore, a thermally conductive element between the coolant inlet and the coolant outlet allows more precise control of the system temperature. The specific heat transfer allows control and optimization of the temperature at the desired sites through the property of the thermally conductive element as passive element itself. This is particularly advantageous in situations where accurate temperature control is necessary for optimizing the operation of the system.

In summary, the use of a thermally conductive element between the coolant inlet and the coolant outlet provides efficient heat transfer, reduction of heat losses, improved temperature distribution and precise passive temperature control. This can improve the performance and reliability of the cooling circuit, which leads to a stable operating environment and to a longer service life of the components involved.

According to one embodiment, the thermally conductive element comprises copper.

One advantage of using copper as thermally conductive element between the coolant inlet and the coolant outlet is its high thermal conductivity. Copper is an excellent heat conductor and thus allows efficient transfer of heat energy from one point to another. This allows the thermally conductive element to help to improve heat dissipation and ensure the thermal stability of the system. Furthermore, copper is a robust and durable material well suited for use in cooling systems. It is corrosion-resistant, which leads to a long service life of the thermally conductive element. The use of copper can thus improve the efficiency and reliability of the cooling system and contribute to effective heat dissipation.

According to one embodiment, the thermally conductive element comprises aluminum.

One advantage of using aluminum as thermally conductive element between the coolant inlet and the coolant outlet is its good thermal conductivity. Aluminum is an efficient heat conductor and allows effective transfer of heat energy from one point to another. This allows the thermally conductive element to help to improve heat dissipation and maintain an optimal operating temperature of the system.

Another advantage of aluminum is its low density compared to copper. This means that the use of aluminum as thermally conductive element contributes to a weight reduction of the entire system. This may be especially advantageous in applications requiring high mobility or weight reduction, for example in aerospace or in vehicle manufacturing.

Furthermore, aluminum is corrosion-resistant, which leads to a long service life of the thermally conductive element. It is also more inexpensive than copper, which can lead to cost-effective solutions.

The use of aluminum as thermally conductive element can thus improve the efficiency of the cooling system, allow reductions in weight and contribute to reliable heat dissipation.

According to one embodiment, the thermally conductive element comprises a metal-fiber composite.

One advantage of using a metal-fiber composite as thermally conductive element between the coolant inlet and the coolant outlet is its combination of high strength and good thermal conductivity. The metal-fiber composite consists of a metal matrix reinforced with embedded fibers. This leads to improved mechanical stability and rigidity of the thermally conductive element.

The use of a metal-fiber composite allows efficient heat transfer between the coolant outlet and the coolant inlet. The fibers in the composite material serve as heat conduction channels and allow rapid and uniform distribution of heat energy. At the same time, the metal in the matrix provides high thermal conductivity for effective dissipation of heat.

Another advantage of a metal-fiber composite is its low density compared to a pure metal. This means that the use of this composite material contributes to a weight reduction in the system, which is particularly advantageous in applications requiring high mobility or reductions in weight.

The metal-fiber composite is also corrosion-resistant and can have high mechanical strength, which leads to a long service life of the thermally conductive element.

The use of a metal-fiber composite as thermally conductive element thus allows efficient heat transfer, reductions in weight and improved mechanical stability of the system.

According to one embodiment, the thermally conductive element comprises fins.

One advantage of using a thermally conductive element comprising fins between the coolant inlet and the coolant outlet is the increased surface area available for heat transfer. The fins serve to increase the contact area between the element and the cooling medium, which leads to more efficient heat dissipation.

The arrangement of fins on the thermally conductive element results in more effective transfer of heat energy from one side (coolant outlet) to the other side (coolant inlet). The fins increase the thermal conductivity of the element and improve heat exchange with the surrounding medium, whether it is air or liquid.

Another advantage of fins on the thermally conductive element is that the fluid dynamics of the cooling medium is improved. The fins give rise to channels or swirls which allow better mixing of the coolant and thus further increase the efficiency of heat transfer.

The use of fins on the thermally conductive element leads to a better cooling performance and to more effective heat dissipation. This allows better control of the temperature of the system, which improves the performance and service life of the components.

Furthermore, fins on the thermally conductive element allow a more compact design of the system, since they increase the surface area for heat transfer without requiring additional external heat sinks or heat exchangers.

Altogether, fins on the thermally conductive element provide improved heat transfer, a more efficient cooling performance, a more compact design and better temperature control of the system.

According to one embodiment, the thermally conductive element is a heat pipe.

One advantage of using a thermally conductive element in the form of a heat pipe between the coolant inlet and the coolant outlet is the efficient heat transfer and the improved temperature control.

A heat pipe consists of a closed pipe with a specific heat transfer fluid inside. When heat is applied to one end of the heat pipe, the liquid evaporates and forms vapor. Because of the temperature difference, the vapor travels in the pipe to a cooler site, where it condenses. The condensed vapor releases heat and turns back into liquid which, because of the capillary forces on the inner walls of the heat pipe, is transferred back to the hot end.

The use of a heat pipe as thermally conductive element allows very efficient heat transfer because of the phase change of the heat transfer fluid. This allows rapid and effective transfer of heat from the hottest site (coolant outlet) to the coolest site (coolant inlet).

Furthermore, a heat pipe provides uniform distribution of heat over its entire length. This ensures uniform cooling of the components in the system, and hotspots can be avoided.

A heat pipe is also flexible and can be used in various spatial configurations. This allows adaptation thereof to the specific requirements of the fuel cell system in order to achieve optimum heat transfer and temperature control.

Altogether, the use of a heat pipe as thermally conductive element allows efficient heat transfer, uniform cooling and improved temperature control in the fuel cell system.

According to one embodiment, the coolant comprises methanol and/or ethanol.

Methanol and ethanol have various advantages as coolants. They have a relatively low boiling point, meaning that they can evaporate at relatively high temperatures and thus allow better cooling.

Another advantage is the low viscosity of methanol compared to water. This facilitates flow and reduces the energy consumption of the pump.

Furthermore, methanol and ethanol have a high enthalpy of evaporation. This allows realization of very small mass flow rates in the system, thereby reducing pressure loss. This means that lines and pumps can be dimensioned smaller than with liquid cooling, which leads to a reduction of weight in the system.

According to one embodiment, the at least one fuel cell is a fuel cell stack having at least one base plate, and the base plate comprises the thermally conductive element.

According to one aspect, an aircraft comprises a fuel cell system of the aforementioned construction.

According to one embodiment, the fuel cell system further comprises an ejector, the ejector being in fluid connection with the first portion of the accumulator, with the second portion of the accumulator, with the pump, with the condenser and with the fuel cell and being adapted to mix the coolant in the gas phase from the accumulator with the supercooled coolant from the condenser and to supply the coolant to the fuel cell.

The main function of the ejector is to mix the coolant in the gas phase from the first portion of the accumulator with the supercooled coolant from the condenser and to then supply the coolant to the fuel cell. The ejector uses the pressure difference between the two fluids in order to draw in the coolant in the gas phase and mix it with the supercooled coolant.

The ejector plays a crucial role in mixing and supplying the coolant in the gas phase with the supercooled coolant in the system. It allows efficient use of the available pressure difference and ensures uniform distribution of the coolant for cooling of the fuel cell.

Another advantage is the formation of gas bubbles in the coolant system, which are advantageous for counteracting superheating of the coolant. They help to reduce surface tension, which leads to more effective heat exchange at higher temperatures.

According to one embodiment, the fuel cell system further comprises a bypass line comprising a pump, the coolant inlet being in fluid connection with the coolant outlet via the bypass line.

The bypass line makes it possible to achieve specific circumvention of the normal cooling circuit and to conduct the warm cooling medium directly to the cold cooling medium.

This allows rapid and efficient heat transfer for effective lowering of the temperature of the cooling medium. The bypass line may be used in various applications to allow specific cooling or specific temperature control and to make a preheater/recuperator dispensable.

### BRIEF DESCRIPTION OF THE DRAWINGS

Example embodiments of the disclosure herein are discussed in more detail below with reference to the appended drawings. The illustrations are schematic and not true to scale. The same reference signs denote identical or similar elements. In the figures:

FIG. 1 shows a fuel cell system; and

FIG. 2 shows an aircraft.

### DETAILED DESCRIPTION

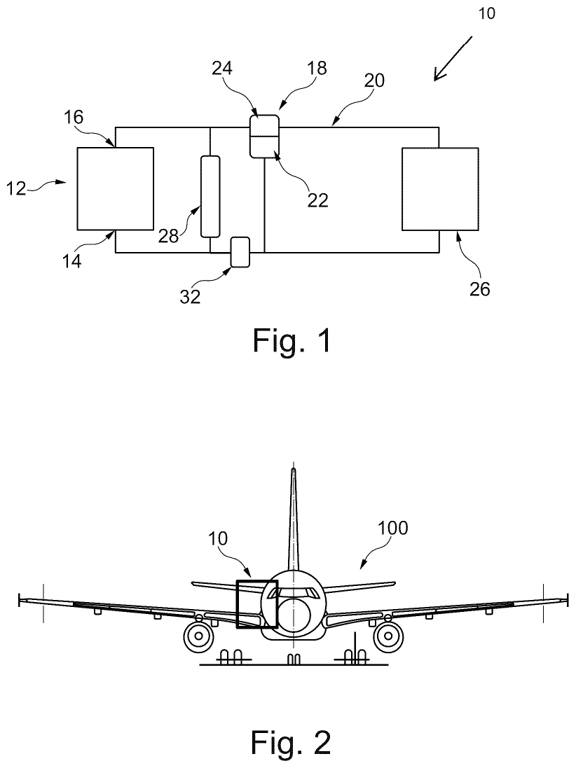

FIG. 1 shows a fuel cell system 10 having a two-phase cooling system. The system 10 comprises at least one fuel cell 12 which has a coolant inlet 14 and a coolant outlet 16. A connection between the coolant inlet and the coolant outlet allows flow of the coolant.

The system 10 also contains an accumulator 18 which is in fluid connection with the fuel cell 12. The accumulator is designed to receive the coolant which flows out of the fuel cell. The coolant is kept in a liquid phase in the first portion of the accumulator 22, whereas it is in a gas phase in the second portion 24.

In addition, there is a condenser 26 which is in fluid connection with the accumulator 18. The condenser 26 condenses and supercools the coolant in order to prevent cavitation in the coolant pump.

A thermally conductive element 28 is provided between the coolant inlet 14 and the coolant outlet 16, the thermally conductive element 28 being adapted to transfer heat from the coolant outlet 16 to the coolant inlet 14.

FIG. 2 shows an aircraft 100 comprising a fuel cell system 10 as described.

A positive effect of this configuration is that the temperature distribution in the fuel cell system 10 is improved. The efficient heat transfer between the coolant inlet 14 and the coolant outlet 16 achieves a more uniform distribution of temperatures in the cooling circuit. This reduces supercooling at the inlet, as a result of heating of the cooling fluid 20 via the thermal element 28. As a result, a pre-heater/recuperator can be dispensed with, which leads to advantageous reductions in weight.

It should additionally be pointed out that “comprising” or “having” does not rule out other elements or steps, and “a”, “an” or “one” does not rule out a multiplicity. It is furthermore pointed out that features or steps that have been described with reference to one of the above example embodiments may also be used in combination with other features or steps of other example embodiments described above. Reference signs in the claims should not be interpreted as restricting.

While at least one example embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the example embodiment(s). In addition, in this disclosure, the terms “comprise” or “comprising” do not exclude other elements or steps, the terms “a”, “an” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

List of reference signs

| | |
|---|---|
| 10 | Fuel cell system |
| 12 | Fuel cell |
| 14 | Coolant inlet |
| 16 | Coolant outlet |
| 18 | Accumulator |
| 20 | Coolant |
| 22 | First portion |
| 24 | Second portion |
| 26 | Condenser |
| 28 | Thermal element |
| 32 | Pump |
| 100 | Aircraft |

1. A fuel cell system having a two-phase cooling system, comprising:
at least one fuel cell having a coolant inlet and a coolant outlet;
a condenser to condense and supercool the coolant; and
a thermally conductive element between the coolant inlet and the coolant outlet, the thermally conductive element being configured to transfer heat from the coolant outlet to the coolant inlet.

2. The fuel cell system of claim 1, further comprising an accumulator for phase separation into gas phase and liquid phase to take place in the accumulator, the accumulator being in fluid connection with the fuel cell and being adapted to contain coolant which flows out of the fuel cell in a liquid phase in a first portion and in a gas phase in a second portion.

3. The fuel cell system of claim 1, wherein the thermally conductive element comprises copper.

4. The fuel cell system of claim 1, wherein the thermally conductive element comprises aluminum.

5. The fuel cell system of claim 1, wherein the thermally conductive element comprises a metal-fiber composite.

6. The fuel cell system of claim 1, wherein the thermally conductive element comprises fins.

7. The fuel cell system of claim 1, wherein the thermally conductive element is a heat pipe.

8. The fuel cell system of claim 1, wherein the at least one fuel cell is a fuel cell stack having at least one base plate, and the base plate comprises the thermally conductive element.

9. The fuel cell system of claim 1, wherein the at least one fuel cell is a fuel cell stack having a media module, the media module comprising the thermally conductive element.

10. The fuel cell system of claim 1, wherein the coolant comprises methanol and/or ethanol.

11. An aircraft comprising the fuel cell system of claim 1.
